(19) United States
(12) Patent Application Publication
(10) Pub. No.: US 2023/0153143 A1
(43) Pub. Date: May 18, 2023

(54) GENERIC APPROACH FOR VIRTUAL DEVICE HYBRID COMPOSITION

(71) Applicant: Intel Corporation, Santa Clara, CA (US)

(72) Inventors: SHAOPENG HE, Shanghai (CN); ANJALI SINGHAI JAIN, Portland, OR (US); UTKARSH Y. KAKAIYA, Folsom, CA (US); YADONG LI, Portland, OR (US); ELIEL LOUZOUN, Jerusalem (IL); KUN TIAN, Shanghai (CN); BRADLEY BURRES, Waltham, MA (US); RORY HARRIS, Vancouver (CA); YAN ZHAO, Shanghai (CN)

(73) Assignee: Intel Corporation, Santa Clara, CA (US)

(21) Appl. No.: 18/097,897

(22) Filed: Jan. 17, 2023

(30) Foreign Application Priority Data
Jun. 7, 2022 (CN) PCT/CN2022/097397
Dec. 2, 2022 (CN) PCT/CN2022/136175

(51) Int. Cl. G06F 9/455; G06F 13/42

(52) U.S. Cl. CPC G06F 9/45558; G06F 13/4221; G06F 2009/45579; G06F 2213/0026

(57) ABSTRACT

Creating hybrid virtual devices using a plurality of physical functions. A processor of a device may identify a plurality of physical functions accessible to the device, the plurality of physical functions including a first physical function and a second physical function. The processor may create a virtual device to comprise the first physical function to provide a first capability and the second physical function to provide a second capability, wherein the first capability and second capability are different capabilities.

This application claims the benefit of and priority to previously filed U.S. patent application Ser. No. 18/072,544 filed Nov. 30, 2022, which claims the benefit of and priority to previously filed Patent Cooperation Treaty (PCT) Application No. PCT/CN2022/097397 filed Jun. 7, 2022, which are hereby incorporated by reference in their entireties.

### BACKGROUND

Conventional techniques for hardware virtualization include a creating a virtual device using a physical function (PF) which enables virtualization and exposes virtual functions (VFs). However, these conventional solutions may be limited to supporting a single physical function. In some situations, a virtual device may need different capabilities from more than one PF. Conventional solutions therefore may not be able to compose a virtual device that includes capabilities from more than one PF.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7 illustrates an aspect of the subject matter in accordance with one embodiment.

FIG. 8 illustrates an aspect of the subject matter in accordance with one embodiment.

### DETAILED DESCRIPTION

Embodiments disclosed herein provide a generic approach for composing hybrid virtual devices using multiple physical functions (PFs) of one or more physical devices. Generally, embodiments disclosed herein may use a primary PF that is extended to include the functionality of one or more secondary PFs of one or more secondary devices. The primary PF and secondary PF may each provide different capabilities. The secondary PF may be supported by an assignable device interface (ADI) manager executing in offload hardware coupled to host hardware, wherein the host hardware executes one or more virtual machines (VMs) and/or containers (e.g., in a cloud computing environment). The ADI manager may compose a hybrid virtual device using the secondary PF and different capabilities from the secondary PFs. The ADI manager may communicate with secondary devices to discover the different capabilities of the secondary PFs. In some embodiments, to communicate with an external secondary device, the ADI manager may use a direct interface, such as a Peripheral Component Interconnect-enhanced (PCIe) peer-to-peer communications. In some embodiments, the ADI manager may communicate with internal devices (e.g., PFs of other devices provided by the offload hardware) using internal registers accessible via internal device interconnections (e.g., PCIe public interconnections, direct memory access (DMA), etc.). In some embodiments, the ADI manager may communicate with external devices that provide PFs by accessing registers of these external devices using PCIe public interconnections and/or DMA. Furthermore, device drivers may support the primary PFs as well as the secondary PFs, and treat all PF registers equally as memory-mapped input/output (MMIO) host physical addresses (HPAs).

Advantageously, embodiments disclosed herein offload physical resource virtualization from the host hardware to the offload hardware. Doing so allows virtualization to be moved from the host kernel of the host hardware to offload hardware (e.g., in the kernel and/or user space of the offload hardware) which may improve security, as software executing on the host hardware may be unable to maliciously access virtual devices, secure data, and/or hardware configuration information. Furthermore, by disclosing a primary PF that includes one or more secondary PFs, a dedicated ADI manager may not be needed for each physical device being virtualized. Instead, the ADI manager of the offload hardware may compose virtual devices using different capabilities of different physical devices. Doing so may improve system performance by facilitating the composition of numerous different types of virtual devices using PFs from any number of physical devices.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

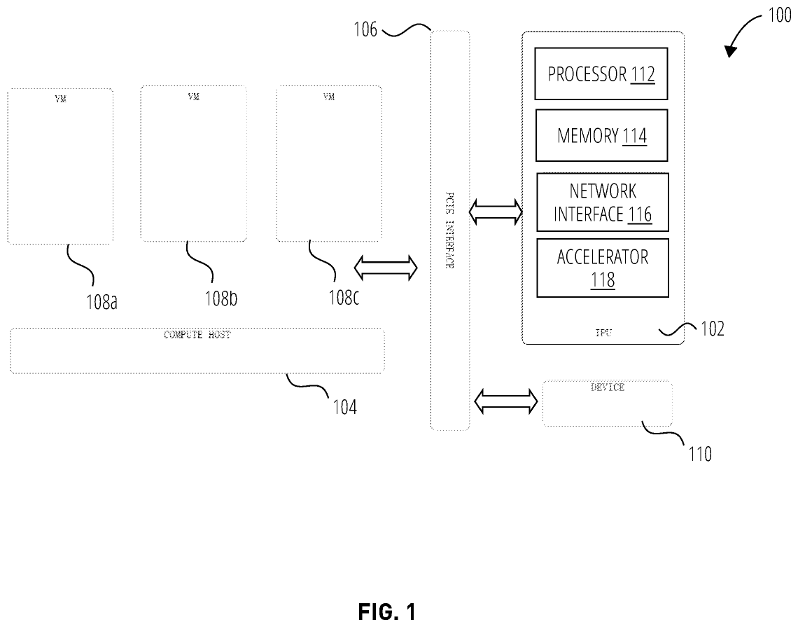

FIG. 1 is a schematic illustrating an operating environment 100. The operating environment 100 comprises an Infrastructure Processing Unit (IPU) 102, host hardware 104, and a device 110 coupled via a PCIe interface 106. The IPU 102, host hardware 104, device 110, and PCIE interface 106 may be implemented in circuitry. For example, the IPU 102, host hardware 104, device 110, and PCIE interface 106 may be communicably coupled components of a compute node, server blade, server rack, or any other computing hardware. The host hardware 104 includes at least one processor circuit and memory (each not pictured). The IPU 102 also includes at least one processor 112, memory 114, an accelerator 118, and a network interface device 116 (e.g., a wired and/or wireless Ethernet network interface). The network interface device 116 may provide an interface to other devices via a network (e.g., a local area network (LAN), a wide area network (WAN), the Internet, etc.) and may support the Institute of Electrical and Electronics Engineers (IEEE) suite of Ethernet standards (e.g., 802.1, 802.3, etc.). The device 110 may be any type of peripheral device, such as a PCIe-compatible device. Although the PCIe interface 106 is used as a reference example of an interface, other interfaces may be used in the operating environment 100. For example, a Compute Express Link® (CXL) interface, a peripheral component interconnect (PCI), interface, a universal serial bus (USB) interface, a serial peripheral interconnect (SPI), an integrated interconnect (I2C), or a Universal Chiplet Interconnect Express (UCIe) interface may be used instead of the PCIe interface 106. Therefore the device 110 may be a USB device, PCI device, PCIe device, CXL device, UCIe device, I2C, and/or an SPI device. The IPU 102 further includes a direct memory access (DMA) engine to facilitate DMA transactions.

The host hardware 104 is representative of one or more processors and memory to execute one or more virtual machines (VMs), such as VM 108a, VM 108b, and VM 108c. The IPU 102 includes one or more programmable or fixed function processors to perform offload of operations that could have been performed by processors of the host hardware 104. The IPU 102 may therefore be considered as an “offload device.” More generally, the IPU 102 may perform virtual switch operations, manage storage transactions (e.g., compression, cryptography, virtualization), and manage operations performed on other IPUs, compute nodes, servers, and/or devices.

For example, as shown, the IPU 102 may handle I/O, manage resources, implement security, and control. Conventionally, I/O, resources, security, and control may be performed by the host hardware 104. These functions include virtualization of devices, such as the device 110. The device 110 is representative of any type of device, such as a network interface device, accelerator device, storage device, and the like. Although depicted as external to the IPU 102, in some embodiments, the device 110 is a component of the IPU 102. Similarly, although depicted as external to the host hardware 104, in some embodiments, the device 110 is a component of the host hardware 104. The device 110 may be virtualized by the IPU 102 for the VMs 108a-108c using the scalable input/output virtualization (S-IOV) architecture. Similarly, the accelerator 118 and network interface device 116 may be virtualized using the S-IOV architecture. Therefore, the device 110, network interface device 116, and the accelerator 118 are S-IOV compliant devices. However, allowing the host hardware 104 to execute VMs and handle these functions may pose security risks, as the VMs (or other actors executing on the host hardware 104) may be able to maliciously access data, configuration information, and/or resources. Advantageously, therefore, moving these functions to the IPU 102 may reduce these security risks.

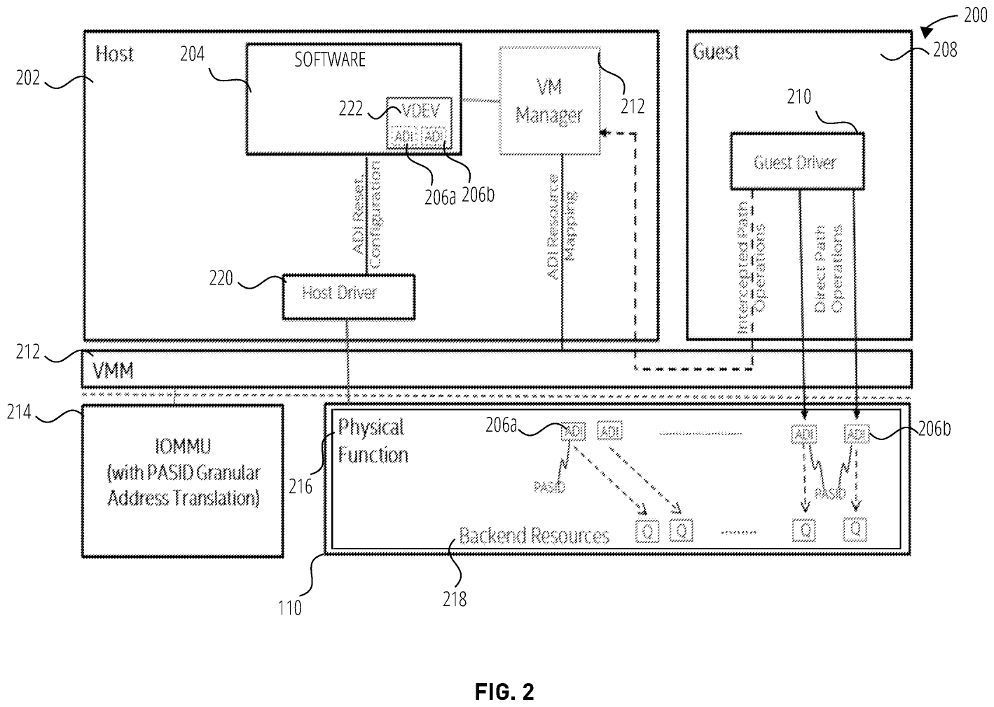

FIG. 2 is a schematic illustrating an operating environment 200 that supports the 5-IOV architecture to virtualize a device such as a device 110, the accelerator 118, and/or the network interface device 116. As shown, the operating environment of FIG. 2 may include a host OS 202, a guest OS 208, a VMM 212, an input/output memory management unit (IOMMU) 214, and the device 110. Host OS 202, guest OS 208, and/or VMM 212 may execute on the host hardware 104. Host OS 202 may include a host driver 220 and guest OS 208 may include a guest driver 210.

As shown, host OS 202 may include software 204 which may compose a virtual device (VDEV) 222 for the guest OS 208. In some embodiments, VDEV 222 may include virtual capability registers configured to expose device (or “device-specific”) capabilities to one or more components of operating environment 200. In various embodiments, virtual capability registers may be accessed by guest driver 210 of the device 110 to determine device capabilities associated with VDEV 222. The VDEV 222 may include one or more assignable device interfaces (ADIs) (also referred to as “assignable interfaces”), including an ADI 206a and an ADI 206b. In some embodiments, an ADI may be assigned, for instance, by mapping the ADIs 206a-206b into a MMIO space of the VDEV 222. An ADI generally refers to the set of backend resources 218 of the device 110 that are allocated, configured, and organized as an isolated unit, forming the unit of device sharing of the device 110. The type and number of backend resources 218 grouped to compose a given ADI 206a, 206b, may be specific to the device 110. An ADI 206a, 206b may be associated with a device context, rather than with specific device resources. As another example, the backend resources 218 of the ADIs 206a-206b may include one or more shared work queues. A repository (not pictured) or other data structure may store a plurality of different ADIs and the respective attributes of each ADI.

For example, if the device 110 is a network controller, the ADIs 206a-206b may provide backend resources 218 that include transmit queues and receive queues associated with a virtual switch interface. As another example, if the device 110 is a storage device, the ADIs 206a-206b may provide backend resources 218 that include command queues and completion queues associated with a storage namespace. As yet another example, if the device 110 is a graphics processing unit (GPU), the ADIs 206a-206b may provide backend resources 218 that include dynamically created graphics or compute contexts. Embodiments are not limited in these contexts.

The IOMMU 214 may be configured to perform memory management operations, including address translations between virtual memory spaces and physical memory. As shown, the IOMMU 214 may support translations at the Process Address Space ID (PASID) level. Generally, a PASID may be assigned to each of a plurality of processes executing on the host hardware 104 (e.g., processes associated with guest OS 208 and/or VMs 108a-108c). Doing so enables sharing of the device 110 across multiple processes while providing each process a complete virtual address space.

Conventionally, the operating environment 200 requires that each device 110 to be virtualized be associated with a respective instance of the software 204. Each software 204 instance may therefore generate a VDEV 222 for the associated device 110. Conventionally, therefore, if multiple devices 110 are to be virtualized, each device 110 must be associated with a respective instance of the software 204 for creation of a respective VDEV 222. As such, a VDEV 222 conventionally is limited to supporting a single PF, such as the PF 216 of device 110.

Advantageously, however, embodiments disclosed herein may permit the creation of a virtual device that includes multiple physical functions. The multiple physical functions may be provided by one or more devices 110 and/or components of the IPU 102.

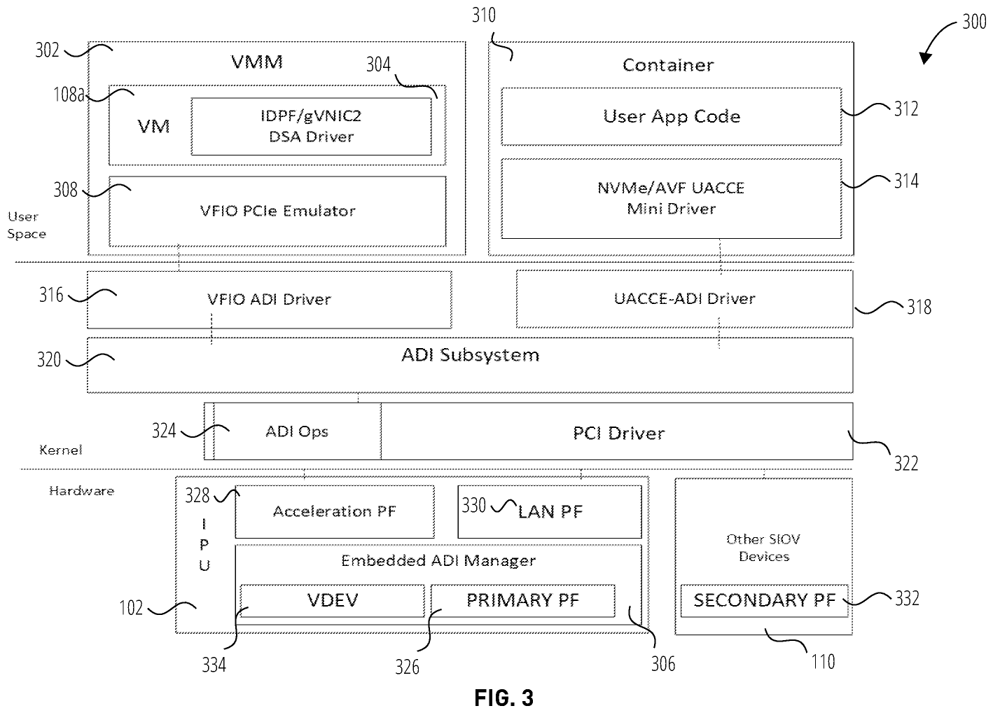

FIG. 3 is a schematic 300 illustrating an operating environment for composing a virtual device using hybrid resources. As shown, a VMM 302 (also referred to as a hypervisor) may execute or manage a VM, such as the VM 108a. The VM 108a may include a device driver 304 for a device such as the device 110. The VMM 302 may further include a virtual function I/O (VFIO) PCIe emulator 308. A container 310 may execute a user application 312 and a mini driver 314. The VMM 302, VM 108a, and/or the container 310 may execute on the host hardware 104 and in user space.

Kernel space may include a VFIO ADI driver 316, a UACCE ADI driver 318, an ADI subsystem 320, and a PCI driver 322 including an ADI ops 324 driver. The VFIO ADI driver 316 may correspond to a driver for a pass-through device, such as the IPU 102 and/or the device 110. Generally, the VFIO ADI driver 316 uses a device template to compose a virtual AVF device using the mapping between the ADI and the register addresses in the ADI entry. Therefore, the VFIO ADI driver 316 preserves the attributes of the device and allows access to the device using the same driver as the corresponding host driver. The Unified/User-space-access-intended Accelerator Framework (UACCE) ADI driver 318 provides Shared Virtual Addressing (SVA) between accelerators and processes, allowing an accelerator device (e.g., the device 110 and/or an accelerator component of the IPU 102) to access any data structures in the host hardware 104. Because of the unified address space provided by the UACCE ADI driver 318, hardware and user space processes can share the same virtual addresses when communicating. Furthermore, the VFIO ADI driver 316 implements VFIO user space interfaces based on different ADIs. Therefore, such VFIO user space interfaces may be a standard PCIe device having a standard PCIe configuration space. The UACCE ADI driver 318 may be paired with the mini driver 314 which allows the UACCE ADI driver 318 to pass through the ADI hardware to user space via the mini driver 314.

The PCI driver 322 is representative of any PCI driver that supports virtualization, including standard drivers compliant with the PCI or PCIe specification (e.g., an S-IOV PCIe compliant driver). One example of the PCI driver 322 is the PCI-stub driver. The PCI driver 322 may have two modes, a primary mode and a secondary mode. Therefore, when associated with a primary PF 326, the PCI driver 322 may be bound to the primary PF 326 and operate in the primary mode. Similarly, when associated with a secondary PF 332, the PCI driver 322 may be bound to the secondary PF 332 and operate in the secondary mode. Furthermore, the primary PF 326 may control any number of secondary PFs 332. More generally, the primary PF 326 may provide at least a first capability and the secondary PF 332 may provide at least a second capability, where the first and second capabilities are different capabilities.

The ADI subsystem 320 is a kernel-space component of the embedded ADI manager 306 of the IPU 102. The ADI subsystem 320 generally accesses different virtual devices, such as the VDEV 334, as PCIe capabilities. The VDEV 334 may include the components of the VDEV 222 (e.g., virtual capability registers, one or more ADIs, etc.). The embedded ADI manager 306 of the IPU 102 is an embedded application (or other executable code) that is configured to compose VDEVs such as the VDEV 334 using a primary PF 326 and one or more secondary PFs 332. The embedded ADI manager 306 may also be referred to as a “virtual device composition module (VDCM)). In some embodiments, the primary PF 326 may be the acceleration PF 328 (e.g., a physical function of an accelerator device of the IPU 102 which provides a set of acceleration capabilities). In some embodiments, the primary PF 326 may be the LAN PF 330 (e.g., a physical function of the network interface device 116 of the IPU 102 which provides a set of network capabilities). In some embodiments, the primary PF 326 may be associated with another physical function provided by the IPU 102 and/or the device 110. In some embodiments, the secondary PFs 332 may be associated with one or more other devices 110, each of which provide a respective set of capabilities. In some embodiments, the secondary PFs 332 may include the acceleration PF 328 and/or the LAN PF 330, each of which provides a respective set of capabilities. Generally, the primary PF 326 may include resources such as control registers, status registers, BAR registers, one or more interrupt message stores (IMS), and message-signaled interrupts (MSI-X). Similarly, the secondary PF 332 may include resources such as control registers, status registers, BAR registers, one or more interrupt message stores, and one or more message-signaled interrupts.

Generally, to compose the VDEV 334, the embedded ADI manager 306 may determine information associated with the secondary PF 332. This information may include PCI Base Address Register (BAR) ranges of the associated device 110. In embodiments where the primary PF 326 and the secondary PF 332 are provided by internal components of the IPU 102 (e.g., the LAN PF 330 and/or the acceleration PF 328), the embedded ADI manager 306 may read the information (e.g., the BAR ranges and any associated values) directly from the devices (e.g., in one or more registers) using internal interconnections (e.g., PCIe interconnections, peer-to-peer PCIe translations, DMA, etc.). In embodiments where the secondary PF 332 is associated with a device other than the IPU 102 (e.g., the device 110), the embedded ADI manager 306 may access the registers via PCIe peer-to-peer communications (e.g., peer-to-peer PCIe translations, DMA, etc.). In some embodiments, the embedded ADI manager 306 includes a cloud agent running on the host hardware 104 to receive the information (e.g., via tools such as lspci and/or PCIe peer-to-peer communications). The agent may pass the information to a cloud orchestrator system which provides the information to the embedded ADI manager 306.

Once the embedded ADI manager 306 receives the information for each secondary PF 332, the embedded ADI manager 306 may compose the VDEV 334 using the primary PF 326 and secondary PFs 332. For example, the VDEV 334 may include one or more ADIs, where each ADI includes a mapping between virtualized registers and the BARs of the underlying hardware. After the registers of the primary PF 326 and the secondary PFs 332 are created into an ADI entry and passed to the ADI OPs 324 of the PCI driver 322, the registers may be used as MMIO host physical addresses by software.

To bind a primary PF 326 to the PCI driver 322, the device associated with the primary PF 326 must support a PCIe ADI extended capability (e.g., the ability to generate hybrid VDEVs such as the VDEV 334 using multiple PFs, including primary PF 326 and at least one secondary PF 332). The device associated with the primary PF 326 may also provide a secondary capability that stores information regarding each secondary PF 332. The PCI driver 322 may then take over the device associated with the secondary PF 332 (e.g., the device 110) and initialize the device to operate in secondary mode. If secondary devices are bound to other drivers, the master driver binding may fail, causing the embedded ADI manager 306 to generate an error message in a log.

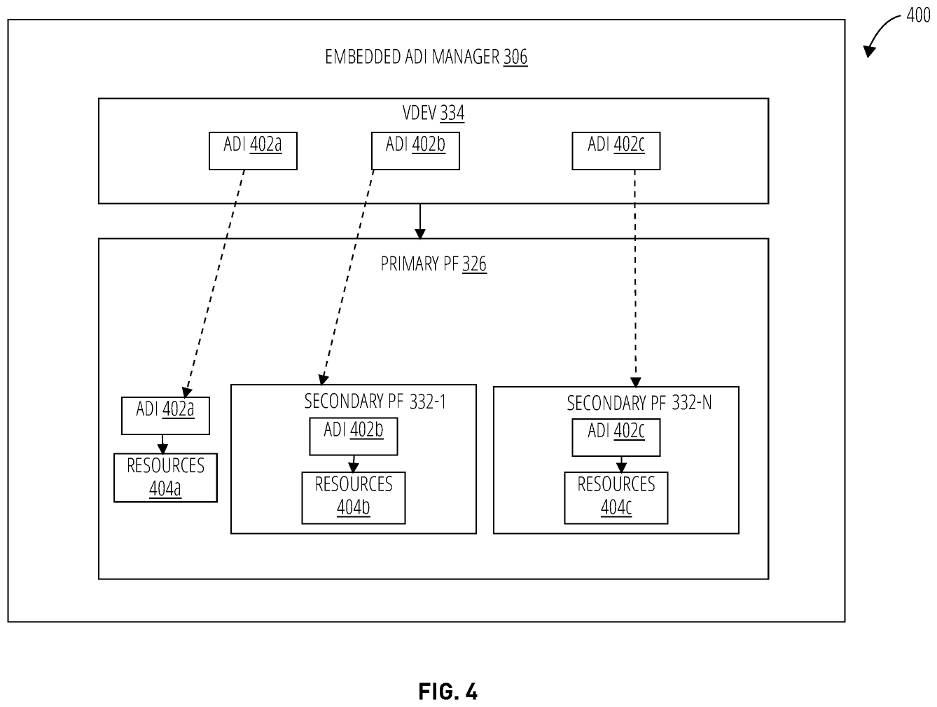

FIG. 4 is a schematic 400 illustrating the VDEV 334 in greater detail. As shown, the VDEV 334 includes ADIs 402a, 402b, and 402c. The ADIs 402a-402c may be similar to the ADIs 206a-206b. As shown, the primary PF 326 includes the ADI 402a which is tied to backend resources 404a of the primary PF 326. Similarly, the primary PF 326 includes secondary PF 332-1 and secondary PF 332-N. As shown, secondary PF 332-1 includes ADI 402b which is mapped to backend resources 404b. Similarly, secondary PF 332-N includes ADI 402c which is mapped to backend resources 404c.

The embedded ADI manager 306 may compose the VDEV 334 using a primary PF 326, secondary PF 332-1, and secondary PF 332-N. Therefore, for example, if primary PF 326 is associated with LAN PF 330, secondary PF 332-1 may be associated with the acceleration PF 328, and secondary PF 332-N may be associated with device 110. As another example, each secondary PF 332-1 through 332-N may be associated with one or more devices 110. For example, secondary PF 332-1 may be associated with a storage device 110 and secondary PF 332-N may be associated with a GPU device 110. Embodiments are not limited in this context.

Generally, the registers of different secondary PFs 332 are arranged such that these hardware registers can be directly accessed by the application 312. However, since multiple secondary PFs 332 of multiple devices 110 may be supported, the embedded ADI manager 306 may distinguish these secondary PFs 332 based on their respective BAR addresses. A cloud orchestrator (e.g., a cloud management system) may compose a virtual device map between the emulated registers of the VDEV 334 and the physical registers of the associated device 110. Doing so informs the embedded ADI manager 306 what virtual (or emulated) registers map to which physical registers. When an ADI is created, a mapping between a virtual register and a physical register is created (and/or a mapping between a virtual register and an emulated register).

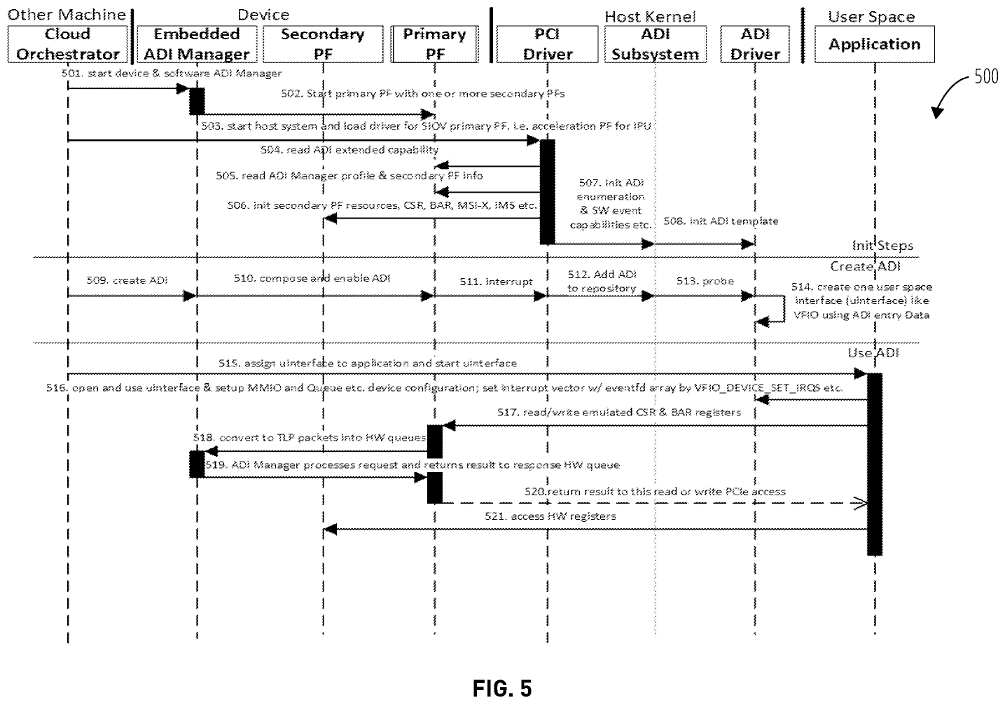

FIG. 5 illustrates a timing diagram 500 to provide a generic approach for composing virtual devices using multiple PFs of one or more physical devices. Generally, in the timing diagram 500, items 501-508 may correspond to system initialization steps, 507-512 may correspond to ADI creation, and items 513-521 may correspond to using the ADI, where items 516-520 corresponding to software-intercepted and/or emulated registers. Embodiments are not limited in these contexts.

As shown, at 501, cloud orchestrator software executing on a cloud system may start the system including the host hardware 104, IPU 102, and one or more devices 110. At 502, the embedded ADI manager 306 may start the primary PF 326 including one or more secondary PFs 332. At 503, the host system may load the PCI driver 322 for the primary PF 326, where the PCI driver 322 supports primary PFs 326 and secondary PFs 332. For example, primary PF 326 may be the acceleration PF 328 and the PCI driver 322 may be for the associated accelerator of the IPU 102. At 504, the PCI driver 322 may read the ADI extended capabilities of the primary PF 326 to identify one or more secondary PFs 332 associated with the primary PF 326. For example, the secondary PF 332 may be provided by the device 110. As another example, the secondary PF 332 may be the LAN PF 330. At 505, the PCI driver 322 may read the profile of the embedded ADI manager 306 and the information associated with the secondary PF 332. At 507, the PCI driver 322 may initialize the secondary PF 332 resources, such as control registers, status registers, BAR registers, one or more interrupt message stores, and one or more message-signaled interrupts. At 507, the PCI driver 322 initializes ADI enumeration and software event capabilities. Doing so may cause one or more ADIs, such as ADIs 402a-402c to be created in the ADI subsystem 320. At 508, the PCI driver 322 may cause the ADI driver (e.g., the VFIO ADI driver 316 and/or the UACCE ADI driver 318) to initialize the ADI template for the ADI created at 507. Generally, 505-508 may be performed for each secondary PF 332 identified at 504. Therefore, for example, if two secondary PFs 332 are identified at 504, 505-508 may be performed for each of the two secondary PFs 332.

At 509, the cloud orchestrator software may instruct the embedded ADI manager 306 to create an ADI, such as ADIs 402a-402c. At 510, the embedded ADI manager 306 may compose and enable the ADI. At 511, the primary PF 326 may generate an interrupt that is transmitted to the PCI driver 322. At 512, the PCI driver 322 adds the ADI to the ADI repository of the embedded ADI manager 306. Doing so creates an entry for the ADI in the repository, where the entry includes the register mappings and any other information describing the ADI. At 513, the ADI subsystem 320 issues a probe to the VFIO ADI driver 316 and/or the UACCE ADI driver 318. At 514, the VFIO ADI driver 316 and/or the UACCE ADI driver 318 may create a user space interface using the data in the ADI repository entry associated with the ADI. An example user space interface is a VFIO interface. However, the application 312 may not be able to use the ADI directly. Instead, the application 312 may access the ADI using the user space interface (e.g., the VFIO interface).

At 515, the cloud orchestrator may assign the user space interface created at 514 to an application such as application 312 and starts the user space interface. At 516, the application 312 may open and use the user space interface. The application 312 may further setup any MMIO and/or queues. The application 312 may further configure the device 110. For example, the application 312 may set an interrupt vector with eventfd by VFIO_DEVICE_SET_IRQS. At 517, the application 312 may read from and/or write to emulated control status registers (CSRs) and/or BAR registers of the primary PF 326. For example, the application 312 may issue a request to read the emulated CSRs and/or BAR registers of the primary PF 326. At 518, the primary PF 326 may convert the request to one or more translation layer packets (TLPs) in one or more hardware queues of the embedded ADI manager 306. At 519, the embedded ADI manager 306 processes the request and returns the result to a hardware response queue of the primary PF 326. For example, the embedded ADI manager 306 may read the emulated CSRs and/or BAR registers of the primary PF 326 and store the resulting data in the hardware response queue. At 520, the primary PF 326 returns the result of the request to the application 312. For example, the primary PF 326 may return the data read from the emulated CSRs and/or bar registers of the primary PF 326 to the application 312. At 521, the application 312 may access one or more hardware registers of the secondary PF 332. For example, the application may read from and/or write to one or more hardware registers of the device 110 associated with the secondary PF 332.

Therefore, as shown at 521 in FIG. 5, if the application 312 requests to access hardware registers, the application 312 may directly access the hardware registers via the secondary PF 332. However, as shown at 517-520, if the application 312 requests to access emulated registers, the application 312 provides the request to the primary PF 326, which uses the embedded ADI manager 306 to process the request and return a result. Advantageously, the registers of different secondary PFs 332 are arranged such that these hardware registers can be directly accessed by the application 312. However, since multiple secondary PFs 332 of multiple devices 110 may be supported, the embedded ADI manager 306 may distinguish these secondary PFs 332 based on their respective BAR addresses. The cloud orchestrator may compose a virtual device map between the emulated registers of the VDEV 334 and the physical registers of the associated device 110. Doing so informs the embedded ADI manager 306 what virtual (or emulated) registers map to which physical registers. When an ADI is created, a mapping between a virtual register and a physical register is created (and/or a mapping between a virtual register and an emulated register).

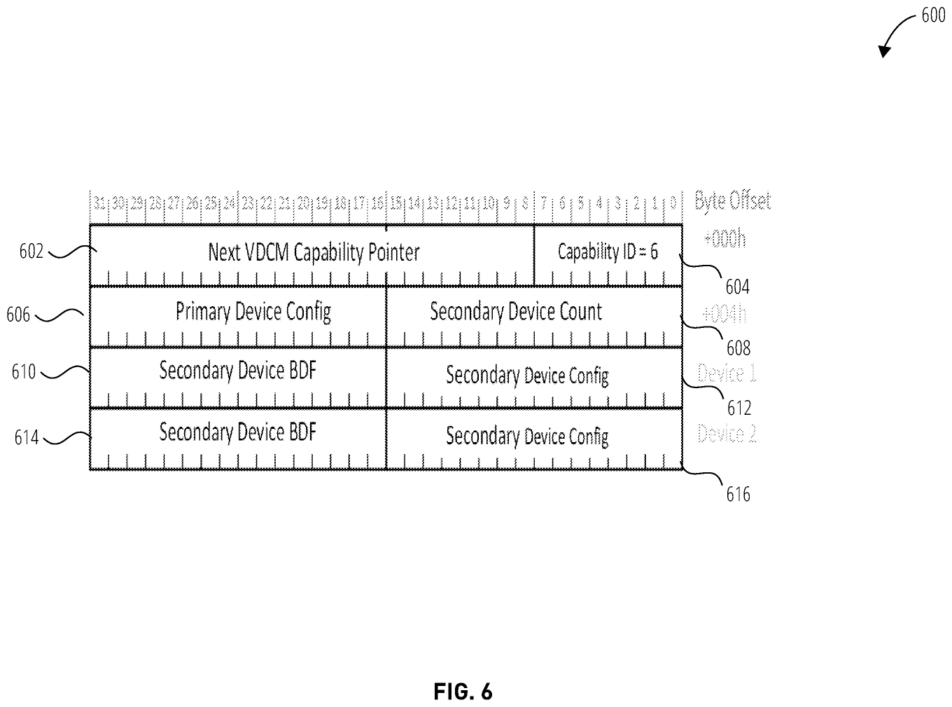

FIG. 6 is a schematic illustrating a data structure 600, according to one embodiment. The data structure 600 may be stored in one or more registers of the IPU 102 associated with the embedded ADI manager 306. Generally, the data structure 600 may be used to create a VDEV 334 including a primary PF 326 and at least one secondary PF 332. As shown, portion 602 stores a pointer to a next capability, e.g., of a VDEV 222. Portion 604 may store an identifier of the capability associated with portion 602. Portion 606 may store a configuration of the device associated with the primary PF 326. Portion 608 may store a count of secondary devices to be included in the VDEV 334. In the example depicted in FIG. 6, two secondary devices may be included in the VDEV 334.

Portion 610 stores a Bus-Device-Function (BDF) of a secondary device (e.g., the first of the two secondary devices to be included in the VDEV 334). Portion 612 stores a configuration of the secondary device. As stated, the configuration of the secondary device may be determined based on PCI peer-to-peer communications with the embedded ADI manager 306 (e.g., when the secondary device is external to the IPU 102, e.g., one of the devices 110), DMA, etc. If the secondary device is associated with the IPU 102, e.g., the accelerator associated with the acceleration PF 328 and/or the network interface device 116 associated with the LAN PF 330, the embedded ADI manager 306 may directly access the configuration information. Similarly, portion 614 stores a BDF of another secondary device (e.g., the second of the two secondary devices to be included in the VDEV 334), while portion 614 stores the configuration for the secondary device.

As stated, an IOMMU of the IPU 102 may support translations at the PASID level. Therefore, a bit in the primary device config portion 606 may specify whether the primary device supports PASID-level translations. Similarly, respective bits in the secondary device config portions 612, 614 may specify whether the secondary device supports PASID-level translations. In some examples, the bit reflecting whether these devices support PASID-level translations may be the zeroth bit in the respective configuration portions 606, 612, and 616.

Generally, if PASID-level translations are enabled for the primary device (e.g., the primary PF 326) and/or the secondary devices (e.g., the secondary PFs 332), the VFIO ADI driver 316 and/or the UACCE ADI driver 318 may call the PCI driver 322 to setup the PASID structures in the IOMMU for these devices. Generally, PASID-level translations may be used for PFs that use direct memory access (DMA). When PASID-level translations are enabled, administration queue emulation may be performed by the LAN PF 330 using the PASID of the LAN PF 330.

Furthermore, if a primary PF 326 or secondary PF 332 uses IMS interrupts (e.g., for I/O queue notifications), the IMS table may be enabled using MSI-X style capabilities defined using the IMS table address, size of the IMS table, mapping parameters, and start parameters. The IMS table address may be in the BAR space of the secondary PF 332 if the IMS table belongs to the secondary PF 332. Because all device BAR spaces are mapped to the HPA in the same way, the IMS table address can be in the primary PF 326 BARs and/or the secondary PF 332 BARs.

In some embodiments, the PCI driver 322 may store a list of permitted devices that can operate as the primary PF 326 and/or the secondary PF 332. For example, the list of permitted devices may include the LAN PF 330, the acceleration PF 328, and/or one or more of the devices 110. Doing so allows the PCI driver 322 to verify the permitted relationships from a VDCM capability (e.g., a capability pointed to by portion 602 of data structure 600).

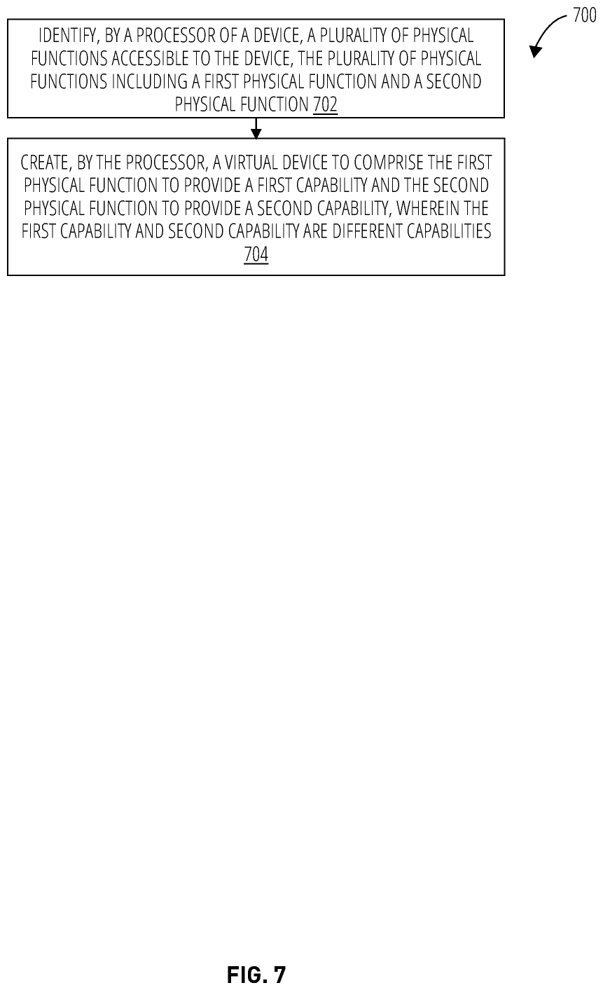

FIG. 7 illustrates an embodiment of a logic flow 700. The logic flow 700 may be representative of some or all of the operations executed by one or more embodiments described herein. For example, the logic flow 700 may include some or all of the operations to compose a virtual device using physical functions one or more physical devices. Embodiments are not limited in this context.

In block 702, logic flow 700 identifies, by the embedded ADI manager 306 executing on the IPU 102, a plurality of physical functions accessible to the IPU 102, the plurality of physical functions including a first physical function and a second physical function. In block 704, logic flow 700 creates, by the embedded ADI manager 306 of the IPU 102, a virtual device to comprise the first physical function to provide a first capability and the second physical function to provide a second capability, wherein the first capability and second capability are different capabilities. For example, the first physical function may be the LAN PF 330 that provides a first set of capabilities, while the second physical function may be the acceleration PF 328 which provides a second set of capabilities.

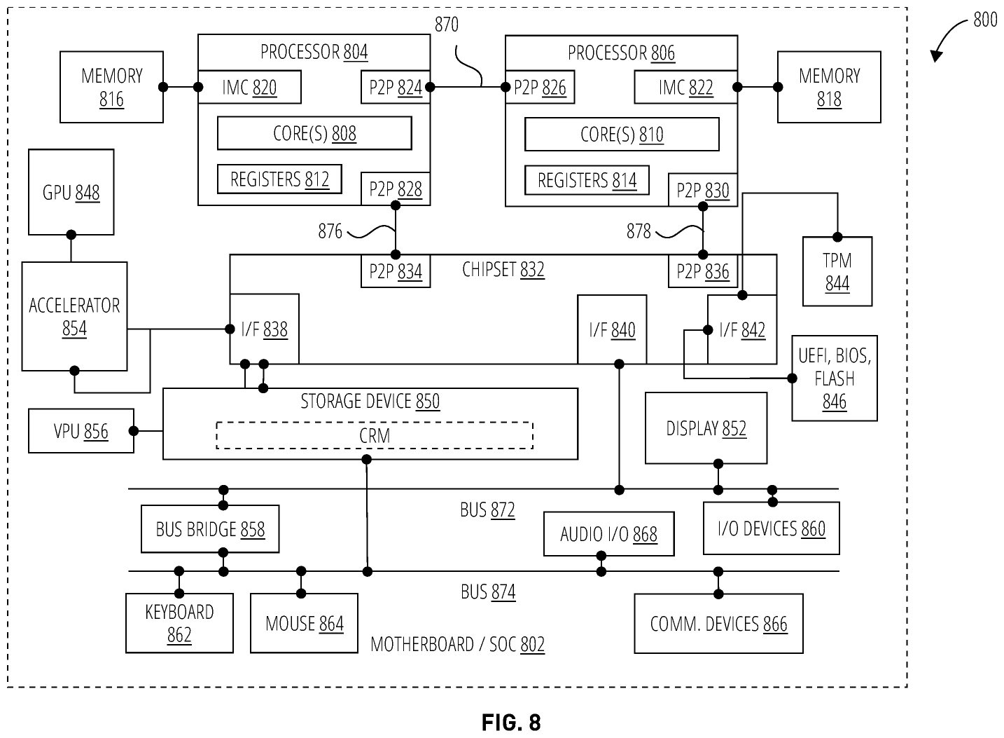

FIG. 8 illustrates an embodiment of a system 800. System 800 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 800 may have a single processor with one core or more than one processor. Note that the term “processor” refers to a processor with a single core or a processor package with multiple processor cores. In at least one embodiment, the computing system 800 is representative of the IPU 102 and the host hardware 104. Stated differently, the IPU 102 and the host hardware 104 may include the components depicted in FIG. 8. Therefore, the IPU 102 and the host hardware 104 may be connected via the chipset 832. More generally, the computing system 800 is configured to implement all logic, systems, logic flows, methods, apparatuses, and functionality described herein with reference to FIGS. 1-7.

As used in this application, the terms “system” and “component” and “module” are intended to refer to a computer-related entity, either hardware, a combination of hardware and software, software, or software in execution, examples of which are provided by the exemplary system 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 8, system 800 comprises a motherboard or system-on-chip(SoC) 802 for mounting platform components. Motherboard or system-on-chip(SoC) 802 is a point-to-point (P2P) interconnect platform that includes a first processor 804 and a second processor 806 coupled via a point-to-point interconnect 870 such as an Ultra Path Interconnect (UPI). In other embodiments, the system 800 may be of another bus architecture, such as a multi-drop bus. Furthermore, each of processor 804 and processor 806 may be processor packages with multiple processor cores including core(s) 808 and core(s) 810, respectively. While the system 800 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 804 and chipset 832. Some platforms may include additional components and some platforms may only include sockets to mount the processors and/or the chipset. Furthermore, some platforms may not have sockets (e.g. SoC, or the like). Although depicted as a motherboard or SoC 802, one or more of the components of the motherboard or SoC 802 may also be included in a single die package, a multi-chip module (MCM), a multi-die package, a chiplet, a bridge, and/or an interposer. Therefore, embodiments are not limited to a motherboard or a SoC.

The processor 804 and processor 806 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 804 and/or processor 806. Additionally, the processor 804 need not be identical to processor 806.

Processor 804 includes an integrated memory controller (IMC) 820 (also referred to as an IOMMU, such as the IOMMU 214) and point-to-point (P2P) interface 824 and P2P interface 828. Similarly, the processor 806 includes an IMC 822 (or IOMMU) as well as P2P interface 826 and P2P interface 830. IMC 820 and IMC 822 couple the processors processor 804 and processor 806, respectively, to respective memories (e.g., memory 816 and memory 818). The IMC 820 and IMC 822 support PASID-level translations as described above. Memory 816 and memory 818 may be portions of the main memory (e.g., a dynamic random-access memory (DRAM)) for the platform such as double data rate type 3 (DDR3) or type 4 (DDR4) synchronous DRAM (SDRAM). In the present embodiment, the memory 816 and the memory 818 locally attach to the respective processors (i.e., processor 804 and processor 806). In other embodiments, the main memory may couple with the processors via a bus and shared memory hub. Processor 804 includes registers 812 and processor 806 includes registers 814.

System 800 includes chipset 832 coupled to processor 804 and processor 806. Furthermore, chipset 832 can be coupled to storage device 850, for example, via an interface (I/F) 838. The I/F 838 may be, for example, a PCIe interface, a Compute Express Link® (CXL) interface, or a Universal Chiplet Interconnect Express (UCIe) interface. Therefore, chipset 832 may include an IOMMU such as IOMMU 214 to support PASID-level translations. Storage device 850 can store instructions executable by circuitry of system 800 (e.g., processor 804, processor 806, GPU 848, accelerator 854, vision processing unit 856, or the like). For example, storage device 850 can store instructions for VMs 108a-108c, VMM 302, container 310, device driver 304, VFIO PCIe emulator 308, application 312, mini driver 314, VFIO ADI driver 316, 318, ADI subsystem 320, PCI driver 322, ADI ops 324, VDEV 334, the embedded ADI manager 306, or the like.

Processor 804 couples to the chipset 832 via P2P interface 828 and P2P 834 while processor 806 couples to the chipset 832 via P2P interface 830 and P2P 836. Direct media interface (DMI) 876 and DMI 878 may couple the P2P interface 828 and the P2P 834 and the P2P interface 830 and P2P 836, respectively. DMI 876 and DMI 878 may be a high-speed interconnect that facilitates, e.g., eight Giga Transfers per second (GT/s) such as DMI 3.0. In other embodiments, the processor 804 and processor 806 may interconnect via a bus.

The chipset 832 may comprise a controller hub such as a platform controller hub (PCH). The chipset 832 may include a system clock to perform clocking functions and include interfaces for an I/O bus such as a universal serial bus (USB), peripheral component interconnects (PCIs), CXL interconnects, UCIe interconnects, serial peripheral interconnects (SPIs), integrated interconnects (I2Cs), and the like, to facilitate connection of peripheral devices on the platform. In other embodiments, the chipset 832 may comprise more than one controller hub such as a chipset with a memory controller hub, a graphics controller hub, and an input/output (I/O) controller hub.

In the depicted example, chipset 832 couples with a trusted platform module (TPM) 844 and UEFI, BIOS, FLASH circuitry 846 via I/F 842. The TPM 844 is a dedicated microcontroller designed to secure hardware by integrating cryptographic keys into devices. The UEFI, BIOS, FLASH circuitry 846 may provide pre-boot code.

Furthermore, chipset 832 includes the I/F 838 to couple chipset 832 with a high-performance graphics engine, such as, graphics processing circuitry or a graphics processing unit (GPU) 848. In other embodiments, the system 800 may include a flexible display interface (FDI) (not shown) between the processor 804 and/or the processor 806 and the chipset 832. The FDI interconnects a graphics processor core in one or more of processor 804 and/or processor 806 with the chipset 832.

Additionally, accelerator 854 and/or vision processing unit 856 can be coupled to chipset 832 via I/F 838. The accelerator 854 is representative of any type of accelerator device (e.g., a data streaming accelerator, cryptographic accelerator, cryptographic co-processor, an offload engine, etc.). One example of an accelerator 854 is the Intel® Data Streaming Accelerator (DSA). The accelerator 854 is representative of the accelerator 118 which provides the acceleration PF 328. The accelerator 854 may be a device including circuitry to accelerate copy operations, data compression, cryptography services such as public key encryption (PKE), cipher, hash/authentication capabilities, decryption, or other capabilities or services. The accelerator 854 can also include circuitry arranged to execute machine learning (ML) related operations (e.g., training, inference, etc.) for ML models. Generally, the accelerator 854 may be specially designed to perform computationally intensive operations, such as cryptographic operations and/or compression operations, in a manner that is far more efficient than when performed by the processor 804 or processor 806. Because the load of the system 800 may include cryptographic and/or compression operations, the accelerator 854 can greatly increase performance of the system 800 for these operations.

Various I/O devices 860 and display 852 couple to the bus 872, along with a bus bridge 858 which couples the bus 872 to a second bus 874 and an I/F 840 that connects the bus 872 with the chipset 832. In one embodiment, the second bus 874 may be a low pin count (LPC) bus. Various devices may couple to the second bus 874 including, for example, a keyboard 862, a mouse 864 and communication devices 866. The communication devices 866 may include the network interface device 116 associated with the LAN PF 330 of the IPU 102. Generally, a network interface provides system 800 the ability to communicate with remote devices (e.g., servers or other computing devices) over one or more networks. Examples of a network interface can include an Ethernet adapter, wireless interconnection components, cellular network interconnection components, USB (universal serial bus), or other wired or wireless standards-based or proprietary interfaces. Furthermore, the accelerator 854 may correspond to the acceleration PF 328 of the IPU 102. The GPU 848, accelerator 854, I/O devices 860, vision processing unit 856, and communication devices 866 are representative of example devices 110.

Furthermore, an audio I/O 868 may couple to second bus 874. Many of the I/O devices 860 and communication devices 866 may reside on the motherboard or system-on-chip(SoC) 802 while the keyboard 862 and the mouse 864 may be add-on peripherals. In other embodiments, some or all the I/O devices 860 and communication devices 866 are add-on peripherals and do not reside on the motherboard or system-on-chip(SoC) 802.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

Example 1 includes an apparatus, comprising: memory to store instructions; and a processor to execute the instructions to cause the processor to: identify a plurality of physical functions including a first physical function and a second physical function; and create a virtual device to comprise the first physical function to provide a first capability and the second physical function to provide a second capability, wherein the first capability and second capability are different capabilities.

Example 2 includes the subject matter of example 1, wherein the first physical function is provided by the apparatus, wherein the second physical function is provided by a peripheral device coupled to the processor via an interconnect.

Example 3 includes the subject matter of example 2, the processor to execute the instructions to cause the processor to: directly access data in a plurality of registers of the apparatus; and configure the first physical function of the virtual device based on the data.

Example 4 includes the subject matter of example 2, the processor to execute the instructions to cause the processor to: access data in a plurality of registers of the peripheral device based on Peripheral Component Interconnect-enhanced (PCIe) peer-to-peer communications; and configure the second physical function of the virtual device based on the data.

Example 5 includes the subject matter of example 2, further comprising another processor coupled to the processor via the interconnect, an application to execute on the another processor to directly access a hardware register of the peripheral device via the second physical function and the interconnect.

Example 6 includes the subject matter of example 2, wherein the first physical function is provided by at least one of a network interface device of the apparatus or an accelerator device of the apparatus, wherein the network interface device, the accelerator device, and the peripheral device are scalable input/output virtualization (S-IOV) devices.

Example 7 includes the subject matter of example 1, the processor to execute the instructions to cause the processor to: receive, from an application executing on another processor and via an interconnect, a request comprising an emulated register; transmit an indication of the request to the primary physical function; and return, by the primary physical function to the application, a response based on the request.

Example 8 includes the subject matter of example 1, wherein the virtual device is to comprise at least one assignable device interface (ADI), wherein the at least one ADI defines a mapping between at least one virtual register of the virtual device and at least one physical register.

Example 9 includes the subject matter of example 1, wherein the first physical function and the second physical function are provided by one or more scalable input/output virtualization (S-IOV) devices.

Example 10 includes a non-transitory computer-readable storage medium, the computer-readable storage medium including instructions that when executed by a processor of a device, cause the processor to: identify a plurality of physical functions accessible to the device, the plurality of physical functions including a first physical function and a second physical function; and create a virtual device to comprise the first physical function to provide a first capability and the second physical function to provide a second capability, wherein the first capability and second capability are different capabilities.

Example 11 includes the subject matter of example 10, wherein the first physical function is provided by the device, wherein the second physical function is provided by a peripheral device coupled to the processor via an interconnect.

Example 12 includes the subject matter of example 11, wherein the instructions further cause the processor to: directly access data in a plurality of registers of the device; and configure the first physical function of the virtual device based on the data.

Example 13 includes the subject matter of example 11, wherein the instructions further cause the processor to: access data in a plurality of registers of the peripheral device based on Peripheral Component Interconnect-enhanced (PCIe) peer-to-peer communications; and configure the second physical function of the virtual device based on the data.

Example 14 includes the subject matter of example 11, wherein an application executing on another device accesses a hardware register of the peripheral device via the second physical function.

Example 15 includes the subject matter of example 11, wherein the first physical function is provided by at least one of a network interface device or an accelerator device, wherein the network interface device, the accelerator device, and the peripheral device are scalable input/output virtualization (S-IOV) devices.

Example 16 includes the subject matter of example 10, wherein the instructions further cause the processor to: receive, from an application executing on another device and via an interconnect, a request comprising an emulated register; transmit, by the processor, an indication of the request to the primary physical function; and return, by the primary physical function to the application, a response based on the request.

Example 17 includes the subject matter of example 10, wherein the virtual device is to comprise at least one assignable device interface (ADI), wherein the at least one ADI defines a mapping between at least one virtual register of the virtual device and at least one physical register.

Example 18 includes the subject matter of example 10, wherein the first physical function and the second physical function are provided by one or more scalable input/output virtualization (S-IOV) devices.

Example 19 includes a method, comprising: identifying, by a processor of a device, a plurality of physical functions accessible to the device, the plurality of physical functions including a first physical function and a second physical function; and creating, by the processor, a virtual device comprising the first physical function as a first capability and the second physical function as a second capability, wherein the first capability and second capability are different capabilities.

Example 20 includes the subject matter of example 19, wherein the first physical function is provided by the device, wherein the second physical function is provided by a peripheral device coupled to the processor via an interconnect.

Example 21 includes the subject matter of example 20, further comprising: directly accessing, by the processor, data in a plurality of registers of the device; and configuring the first physical function of the virtual device based on the data.

Example 22 includes the subject matter of example 20, further comprising: accessing, by the processor, data in a plurality of registers of the peripheral device based on Peripheral Component Interconnect-enhanced (PCIe) peer-to-peer communications; and configuring the second physical function of the virtual device based on the data.

Example 23 includes the subject matter of example 20, wherein an application executing on another device accesses a hardware register of the peripheral device via the second physical function and the interconnect.

Example 24 includes the subject matter of example 20, wherein the first physical function is provided by at least one of a network interface device of the apparatus or an accelerator device of the apparatus, wherein the network interface device, the accelerator device, and the peripheral device are scalable input/output virtualization (S-IOV) devices.

Example 25 includes the subject matter of example 19, further comprising: receiving, from an application executing on another device and via an interconnect, a request comprising an emulated register; transmitting, by the processor, an indication of the request to the primary physical function; and returning, by the primary physical function to the application, a response based on the request.

Example 26 includes the subject matter of example 19, wherein the virtual device is to comprise at least one assignable device interface (ADI), wherein the at least one ADI defines a mapping between at least one virtual register of the virtual device and at least one physical register.

Example 27 includes the subject matter of example 19, wherein the first physical function and the second physical function are provided by one or more scalable input/output virtualization (S-IOV) devices.

Example 28 includes an apparatus, comprising, comprising: means for identifying a plurality of physical functions accessible to a device, the plurality of physical functions including a first physical function and a second physical function; and means for creating a virtual device comprising the first physical function as a first capability and the second physical function as a second capability, wherein the first capability and second capability are different capabilities.

Example 29 includes the subject matter of example 28, wherein the first physical function is provided by the device, wherein the second physical function is provided by a peripheral device coupled to the processor via an interconnect.

Example 30 includes the subject matter of example 29, further comprising: means for directly accessing data in a plurality of registers of the device; and means for configuring the first physical function of the virtual device based on the data.

Example 31 includes the subject matter of example 29, further comprising: means for accessing data in a plurality of registers of the peripheral device based on Peripheral Component Interconnect-enhanced (PCIe) peer-to-peer communications; and means for configuring the second physical function of the virtual device based on the data.

Example 32 includes the subject matter of example 29, wherein an application executing on another device accesses a hardware register of the peripheral device via the second physical function and the interconnect.

Example 33 includes the subject matter of example 29, wherein the first physical function is provided by at least one of a network interface device of the apparatus or an accelerator device of the apparatus, wherein the network interface device, the accelerator device, and the peripheral device are scalable input/output virtualization (S-IOV) devices.

Example 34 includes the subject matter of example 28, further comprising: means for receiving, from an application executing on another device and via an interconnect, a request comprising an emulated register; means for transmitting an indication of the request to the primary physical function; and means for returning, by the primary physical function to the application, a response based on the request.

Example 35 includes the subject matter of example 28, wherein the virtual device is to comprise at least one assignable device interface (ADI), wherein the at least one ADI defines a mapping between at least one virtual register of the virtual device and at least one physical register.

Example 36 includes the subject matter of example 28, wherein the first physical function and the second physical function are provided by one or more scalable input/output virtualization (S-IOV) devices.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. An apparatus, comprising:
memory to store instructions; and
a processor to execute the instructions to cause the processor to:
identify a plurality of physical functions including a first physical function and a second physical function; and
create a virtual device to comprise the first physical function to provide a first capability and the second physical function to provide a second capability, wherein the first capability and second capability are different capabilities.

2. The apparatus of claim 1, wherein the first physical function is provided by the apparatus, wherein the second physical function is provided by a peripheral device coupled to the processor via an interconnect.

3. The apparatus of claim 2, the processor to execute the instructions to cause the processor to:
directly access data in a plurality of registers of the apparatus; and
configure the first physical function of the virtual device based on the data.

4. The apparatus of claim 2, the processor to execute the instructions to cause the processor to:
access data in a plurality of registers of the peripheral device based on Peripheral Component Interconnect-enhanced (PCIe) peer-to-peer communications; and
configure the second physical function of the virtual device based on the data.

5. The apparatus of claim 2, further comprising another processor coupled to the processor via the interconnect, an application to execute on the another processor to directly access a hardware register of the peripheral device via the second physical function and the interconnect.

6. The apparatus of claim 2, wherein the first physical function is provided by at least one of a network interface device of the apparatus or an accelerator device of the apparatus.

7. The apparatus of claim 1, the processor to execute the instructions to cause the processor to:
receive, from an application executing on another processor and via an interconnect, a request comprising an emulated register;
transmit an indication of the request to the primary physical function; and
return, by the primary physical function to the application, a response based on the request.

8. The apparatus of claim 1, wherein the virtual device is to comprise at least one assignable device interface (ADI), wherein the at least one ADI defines a mapping between at least one virtual register of the virtual device and at least one physical register.

9. The apparatus of claim 1, wherein the first physical function and the second physical function are provided by one or more scalable input/output virtualization (S-IOV) devices.

10. A non-transitory computer-readable storage medium, the computer-readable storage medium including instructions that when executed by a processor of a device, cause the processor to:
identify a plurality of physical functions accessible to the device, the plurality of physical functions including a first physical function and a second physical function; and
create a virtual device to comprise the first physical function to provide a first capability and the second physical function to provide a second capability, wherein the first capability and second capability are different capabilities.

11. The computer-readable storage medium of claim 10, wherein the first physical function is provided by the device, wherein the second physical function is provided by a peripheral device coupled to the processor via an interconnect.

12. The computer-readable storage medium of claim 11, wherein the instructions further cause the processor to:
directly access data in a plurality of registers of the device; and
configure the first physical function of the virtual device based on the data.

13. The computer-readable storage medium of claim 11, wherein the instructions further cause the processor to:
access data in a plurality of registers of the peripheral device based on Peripheral Component Interconnect-enhanced (PCIe) peer-to-peer communications; and
configure the second physical function of the virtual device based on the data.

14. The computer-readable storage medium of claim 10, wherein the instructions further cause the processor to:
receive, from an application executing on another device and via an interconnect, a request comprising an emulated register;
transmit, by the processor, an indication of the request to the primary physical function; and
return, by the primary physical function to the application, a response based on the request.

15. A method, comprising:
identifying, by a processor of a device, a plurality of physical functions accessible to the device, the plurality of physical functions including a first physical function and a second physical function; and
creating, by the processor, a virtual device comprising the first physical function as a first capability and the second physical function as a second capability, wherein the first capability and second capability are different capabilities.

16. The method of claim 15, wherein the first physical function is provided by the device, wherein the second physical function is provided by a peripheral device coupled to the processor via an interconnect.

17. The method of claim 16, further comprising:
directly accessing, by the processor, data in a plurality of registers of the device; and
configuring the first physical function of the virtual device based on the data.

18. The method of claim 16, further comprising:
accessing, by the processor, data in a plurality of registers of the peripheral device based on Peripheral Component Interconnect-enhanced (PCIe) peer-to-peer communications; and
configuring the second physical function of the virtual device based on the data.

19. The method of claim 16, wherein an application executing on another device accesses a hardware register of the peripheral device via the second physical function and the interconnect.

20. The method of claim 16, wherein the first physical function is provided by at least one of a network interface device or an accelerator device, wherein the network interface device, the accelerator device, and the peripheral device are scalable input/output virtualization (S-IOV) devices.
